(19) United States
(12) Patent Application Publication
(10) Pub. No.: US 2014/0191945 A1
(43) Pub. Date: Jul. 10, 2014

(54) ELECTRONIC DEVICE AND METHOD FOR ADJUSTING DISPLAY SCREEN

(71) Applicants: HON HAI PRECISION INDUSTRY CO., LTD., New Taipei (TW); HONG FU JIN PRECISION INDUSTRY (WuHan) CO., LTD., Wuhan (CN)

(72) Inventors: XIN-SHU WANG, Wuhan (CN); JIAN-HUNG HUNG, New Taipei (TW); MIN YANG, Wuhan (CN)

(73) Assignees: HON HAI PRECISION INDUSTRY CO., LTD., New Taipei (TW); HONG FU JIN PRECISION INDUSTRY (WUHAN) CO., LTD., Wuhan (CN)

(21) Appl. No.: 14/141,435

(22) Filed: Dec. 27, 2013

(30) Foreign Application Priority Data
Jan. 7, 2013 (CN) 2013100045101

(51) Int. Cl. G09G 5/00

(52) U.S. Cl. CPC G09G 5/003
USPC 345/156

(57) ABSTRACT

In a method for adjusting a display screen of an electronic device, the method receives analog audio signals of a user, transforms the analog audio signals to digital audio signals, detects a first control command including first rotation directions and first rotation angles of the display screen from the digital audio signals, and rotates the display screen according to the first rotation directions and the first rotation angles. The method further obtains second rotation angles of the display screen detected by a gravity sensor of the electronic device, and stops rotating the display screen when the second rotation angles are equal to the first rotation angles.

### BACKGROUND

1. Technical Field

Embodiments of the present disclosure relate to automatic control technology, and particularly to an electronic device and a method for adjusting a display screen of the electronic device.

2. Description of Related Art

Display screens of an electronic device are often fixed in one position or need to be rotated by hand. However, it is inconvenient to adjust the position of the display screen by hand. Therefore, a method for adjusting a display screen of an electronic device using a handheld device is desired.

### BRIEF DESCRIPTION OF THE DRAWINGS

FIG. 1 is a block diagram of a first embodiment of an electronic device including a display screen adjusting system.

FIG. 2 is a block diagram of a second embodiment of the electronic device connected to a server.

FIG. 3 is a block diagram of function modules of the display screen adjusting system included in the electronic device.

FIG. 4 is a flowchart of one embodiment of a method for adjusting a display screen of the electronic device.

FIG. 5 is a schematic diagram of a front view of the display screen.

FIG. 6 is a schematic diagram of a side view of the display screen.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

All of the processes described below may be embodied in, and fully automated via, functional code modules executed by one or more general purpose electronic devices or processors. The code modules may be stored in any type of non-transitory computer-readable medium or other storage device. Some or all of the methods may alternatively be embodied in specialized hardware. Depending on the embodiment, the non-transitory computer-readable medium may be a hard disk drive, a compact disc, a digital video disc, a tape drive or other suitable storage medium.

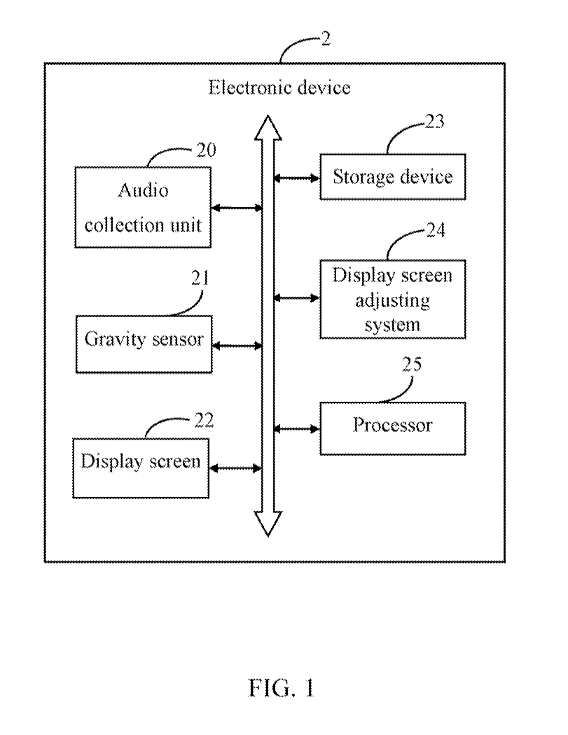

FIG. 1 is a block diagram of a first embodiment of an electronic device 2 including a display screen adjusting system 24. The electronic device 2 further includes an audio collection unit 20, a gravity sensor (G-sensor) 21, a display screen 22, a storage device 23, and at least one processor 25. It should be understood that FIG. 1 illustrates only one example of the electronic device 2 that may include more or fewer components than illustrated, or a different configuration of the various components in other embodiments. In the first embodiment, the electronic device 2 may be a desktop computer, a notebook computer, or a server.

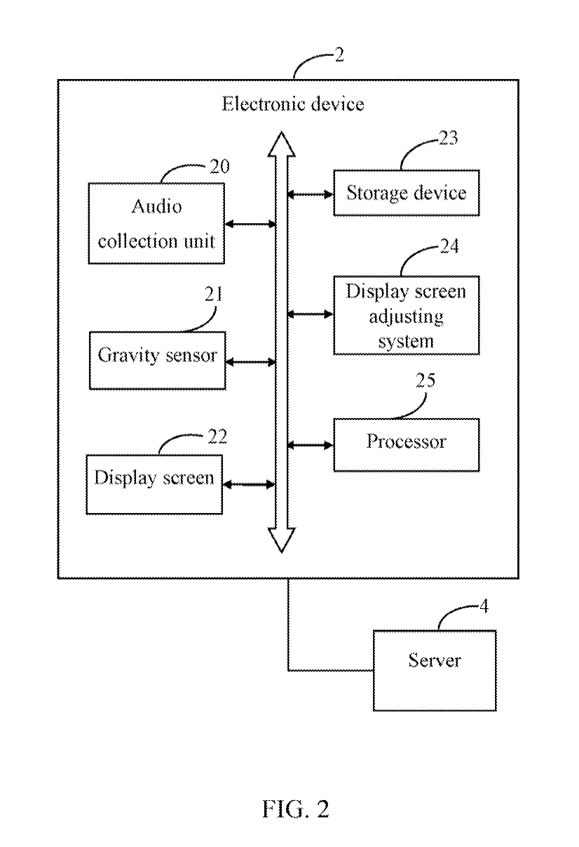

In a second illustrated embodiment, the electronic device 2 is connected to a server 4 through a network (refers to FIG. 2). The network may be a wireless network, such as a WIFI network. In the second embodiment, the server 4 may be a cloud computing center which provides cloud computing services for a plurality of client computers (e.g., the electronic device 2).

In one embodiment, the gravity sensor 21 is used to detect rotation angles of the display screen 22 in an X-axis direction, a Y-axis direction, and an Z-axis direction. The processor 25 is an embedded controller of a single chip microcomputer (SCM), such as a 8032 AH. A working voltage of the processor 25 is about three volts (V).

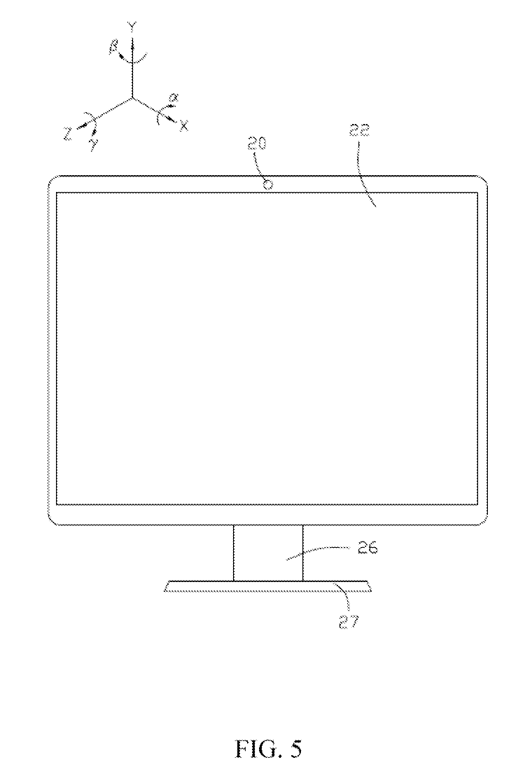

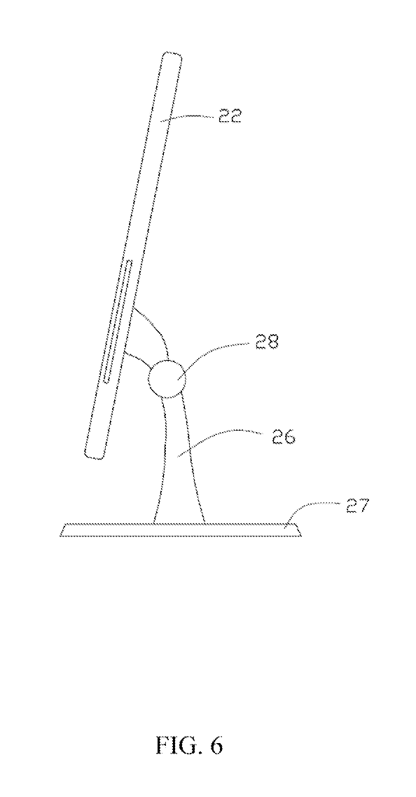

FIG. 5 shows that the audio collection unit 20 is located on a middle position of a top border of the display screen 22, the display screen 22 is connected with a pedestal 27 through a bracket 26. In addition, as shown in FIG. 6, a rotating bearing 28 is positioned in the bracket 26. The rotating bearing 28 is a spherical bearing. A driving motor is also installed in the bracket 26, and the rotating bearing 28 is rotated using the driving motor, so that the display screen 22 is controlled to rotate in accordance with the rotation of the rotating bearing 28.

In one embodiment, the audio collection unit 20 is used to detect analog audio signals of a user of the electronic device 2, and transform the analog audio signals to digital audio signals. For example, the audio collection unit 20 is a microphone.

The display screen adjusting system 24 is used to receive the digital audio signals detected by the audio collection unit 20, transform the digital audio signals to a control command, and rotate the display screen 22 according to the control command. In one embodiment, the display screen adjusting system 24 may include computerized instructions in the form of one or more programs that are executed by the processor 25 and stored in the storage device 23 (or memory). A detailed description of the display screen adjusting system 24 will be given in the following paragraphs.

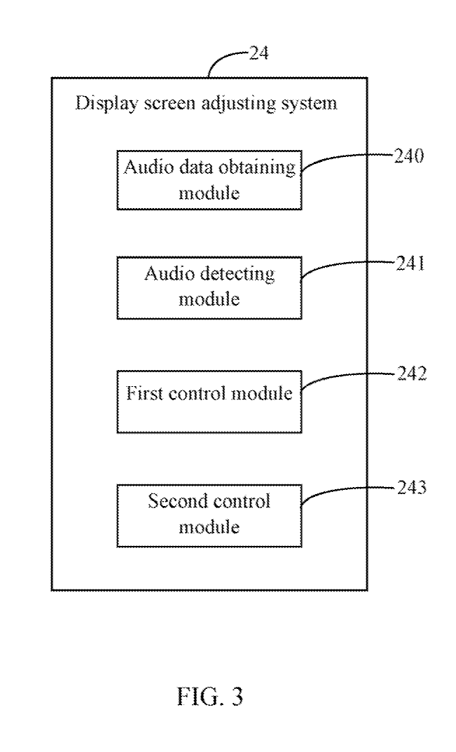

FIG. 3 is a block diagram of function modules of the display screen adjusting system 24 included in the electronic device 2. In one embodiment, the display screen adjusting system 24 may include one or more modules, for example, an audio data obtaining module 240, an audio detecting module 241, a first control module 242, and a second control module 243. In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable medium include CDs, DVDs, BLU-RAY, flash memory, and hard disk drives.

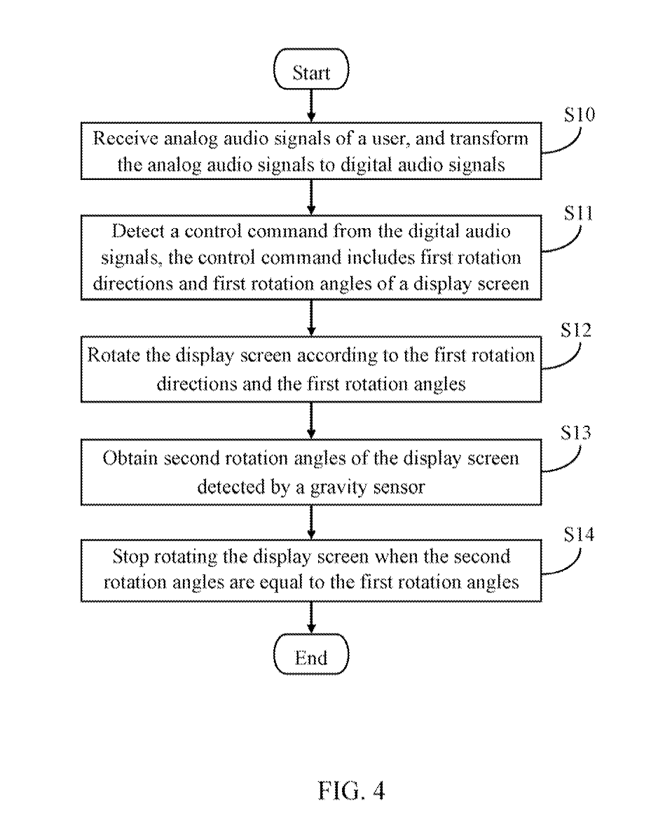

FIG. 4 is a flowchart of one embodiment of a method for adjusting the display screen 22 of the electronic device 2. Depending on the embodiment, additional steps may be added, others removed, and the ordering of the steps may be changed.

In step S10, the audio data obtaining module 240 receives analog audio signals of a user detected by the audio collection unit 20, and transform the analog audio signals to digital audio signals.

In step S11, the audio detecting module 241 detects a control command from the digital audio signals, where the control command includes first rotation directions and first rotation angles of the display screen 22. In one embodiment, the first rotation directions may include a first rotation direction in an X-axis of a three dimensional (3D) coordinate system of the display screen 22 (hereinafter referred to as “first X-axis rotation direction”), a first rotation direction in a Y-axis of the 3D coordinate system of the display screen 22 (hereinafter referred to as “ first Y-axis rotation direction”), and a first rotation direction in an Z-axis of the 3D coordinate system of the display screen 22 (hereinafter referred to as “first Z-axis rotation direction”). As shown in FIG. 5, the X-axis of the 3D coordinate system of the display screen 22 is a horizontal direction of the display screen 22, the Y-axis of the 3D coordinate system of the display screen 22 is a vertical direction of the display screen 22, and the Z-axis of the 3D coordinate system of the display screen 22 is perpendicular to a plane of the display screen 22.

In one embodiment, the first rotation angles may include a first rotation angle in the X-axis (hereinafter referred to as “first X-axis rotation angle”), a first rotation angle in the Y-axis (hereinafter referred to as “first Y-axis rotation angle”), and a first rotation angle in the Z-axis (hereinafter referred to as “first Z-axis rotation angle”).

In one embodiment, the audio detecting module 241 transforms the digital audio signals to a local audio detection device (e.g., Speech SDK) of the electronic device 2, and detects the control command from the digital audio signals using an audio detection algorithm, such as a dynamic time warping (DTW) algorithm. For example, the control command may be to rotate the display screen 22 left (i.e., a negative direction of the X-axis) by thirty degrees.

In step S12, the first control module 242 rotates the display screen 22 according to the first rotation directions and the first rotation angles by controlling the driving motor installed in the bracket 26 to rotate the rotating bearing 28, and then the display screen 22 is rotated.

For example, the first control module 242 rotates the display screen 22 leftward with the first X-axis rotation angle of the display screen 22, if the first X-axis movement direction in the control command is leftward (e.g., a negative direction of the X-axis). The first control module 242 rotates the display screen 22 rightward with the first X-axis rotation angle of the display screen 22, if the first X-axis rotation direction of in the control command is rightward (e.g., a positive direction of the X-axis). The first control module 242 rotates the display screen 22 upward with the first Y-axis rotation angle of the display screen 22, if the first Y-axis rotation direction in the control command is upward (e.g., a positive direction of the Y-axis). The first control module 242 rotates the display screen 22 downward with the first Y-axis rotation angle of the display screen 22, if the first Y-axis rotation direction in the control command is downward (e.g., a negative direction of the Y-axis).

In step S13, the second control module 243 obtains second rotation angles of the display screen 22 detected by the gravity sensor 21. In one embodiment, the gravity sensor 21 detects the second rotation angles of the display screen 22 when the display screen 22 is rotated. As shown in FIG. 5, the second rotation angles may include a second rotation angle “a” in the X-axis of the 3D coordinate system of the display screen 22 (hereinafter referred to as “second X-axis rotation angle”), a second rotation angle “β” in the Y-axis of the 3D coordinate system of the display screen 22 (hereinafter referred to as “second Y-axis rotation angle”), and a second rotation angle “y” in the Z-axis of the 3D coordinate system of the display screen 22 (hereinafter referred to as “second Z-axis rotation angle”).

In step S14, the second control module 243 stops rotating the display screen 22 when the second rotation angles of the display screen 22 are equal to the first rotation angles in the control command.

For example, suppose that “a1”, “a2”, and “a3” represent the first X-axis rotation angle, the first Y-axis rotation angle, and the first Z-axis rotation angle respectively, “b1”, “b2”, and “b3” represent the second X-axis rotation angle, the second Y-axis rotation angle, and the second Z-axis rotation angle respectively. The second control module 243 stops rotating the display screen 22 when “b1=a1”, “b2=a2”, and “b3=a3”, so that a display direction of the display screen 22 is directly opposite to the user's face, and an optimized visual effect is achieved.

In a second embodiment, as shown in FIG. 2, when the audio data obtaining module 240 obtains the digital audio signals, the audio detecting module 241 sends the digital audio signals to a local audio detection device (e.g., Speech SDK) in the electronic device 2, and sends the digital audio signals to a remote audio detection device in the server 4 through the network. Then, the local audio detection device detects a first control command from the digital audio signals. The remote audio detection device detects a second control command from the digital audio signals, and returns the second control command to the electronic device 2.

The first control module 242 determines an optimized control command from the first control command and the second control command, and rotates the display screen 22 according to the rotation directions and the rotation angles in the optimized control command. In the second embodiment, the optimized control command is determined by calculating reliability indexes of the first control command and the second control command using the Bayesian Estimate algorithm or other suitable algorithms, and selecting one control command having a higher reliability index as the optimized control command. For example, if the reliability index of the second control command is higher than the reliability index of the first control command, the second control command is determined to be the optimized control command.

If both of the reliability index of the first control command and the reliability index of the second control command are less than a preset value (e.g., 60%), the audio detecting module 241 displays a prompt message on the display screen 22, to prompt the user to output updated audio signals.

In the second embodiment, when the audio data obtaining module 240 obtains the digital audio signals, the audio detecting module 241 first sends the digital audio signals to the local audio detection device (e.g., Speech SDK) in the electronic device 2. If the local audio detection device does not detect a qualified control command (e.g., the reliability index of the first control command is less than the preset value), the audio detecting module 241 further sends the digital audio signals to the remote audio detection device in the server 4 through the network. Then, the remote audio detection device detects a second control command from the digital audio signals, and returns the second control command to the electronic device 2. If the reliability index of the second control command is less than the preset value, the audio detecting module 241 displays a prompt message on the display screen 22, to prompt the user to output updated audio signals.

If the local audio detection device detects a qualified control command (e.g., the reliability index of the first control command is greater than or equal to the preset value), the audio detecting module 241 determines that the first control command is the qualified control command, and the digital audio signals are not sent to the remote audio detection device of the server 4.

In the first and second embodiments, the audio signals of the user are used to control the display screen 22 to rotate. In other embodiments, the audio signals of the user may be used to control the display screen 22 to execute other suitable operations, such as control the display screen 22 playing videos, playing electronic games, and playing specified software.

It should be emphasized that the above-described embodiments of the present disclosure, particularly, any embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A method for adjusting a display screen of an electronic device, the method comprising:
receiving analog audio signals of a user detected by an audio collection unit installed on the display screen, and transforming the analog audio signals to digital audio signals;
detecting a first control command from the digital audio signals, the first control command comprising first rotation directions and first rotation angles of the display screen;
rotating the display screen according to the first rotation directions and the first rotation angles in the first control command;
obtaining second rotation angles of the display screen detected by a gravity sensor of the electronic device; and
stopping rotating the display screen when the second rotation angles of the display screen are equal to the first rotation angles in the first control command.

2. The method according to claim 1, wherein the first control command is detected from the digital audio signals using a local audio detection device of the electronic device.

3. The method according to claim 2, further comprising:
sending the digital audio signals to a remote audio detection device of a server when a reliability index of the first control command detected by the local audio detection device is less than a preset value; and
receiving a second control command detected by the remote audio detection device of the server.

4. The method according to claim 3, further comprising: displaying a prompt message on the display screen to prompt the user to output updated audio signals when a reliability index of the second control command detected by the remote audio detection device is less than the preset value.

5. The method according to claim 1, wherein the display screen is rotated by controlling a driving motor installed in a bracket of the display screen to rotate a rotating bearing of the bracket according to the first rotation directions and the first rotation angles of the handheld device.

6. An electronic device, comprising:
a processor;
a storage device storing a plurality of instructions, which when executed by the processor, causes the processor to:
receive analog audio signals of a user detected by an audio collection unit installed on a display screen of the electronic device, and transform the analog audio signals to digital audio signals;
detect a first control command from the digital audio signals, the first control command comprising first rotation directions and first rotation angles of the display screen;
rotate the display screen according to the first rotation directions and the first rotation angles in the first control command;
obtain second rotation angles of the display screen detected by a gravity sensor of the electronic device; and
stop rotating the display screen when the second rotation angles of the display screen are equal to the first rotation angles in the first control command.

7. The electronic device according to claim 6, wherein the first control command is detected from the digital audio signals using a local audio detection device of the electronic device.

8. The electronic device according to claim 7, wherein the plurality of instructions further comprise:
sending the digital audio signals to a remote audio detection device of a server when a reliability index of the first control command detected by the local audio detection device is less than a preset value; and
receiving a second control command detected by the remote audio detection device of the server.

9. The electronic device according to claim 8, wherein the plurality of instructions further comprise: displaying a prompt message on the display screen to prompt the user to output updated audio signals when a reliability index of the second control command detected by the remote audio detection device is less than the preset value.

10. The electronic device according to claim 6, wherein the display screen is rotated by controlling a driving motor installed in a bracket of the display screen to rotate a rotating bearing of the bracket according to the first rotation directions and the first rotation angles of the handheld device.

11. A non-transitory storage medium having stored thereon instructions that, when executed by a processor of an electronic device, causes the processor to perform a method for adjusting a display screen of the electronic device, the method comprising:
receiving analog audio signals of a user detected by an audio collection unit installed on the display screen, and transforming the analog audio signals to digital audio signals;
detecting a first control command from the digital audio signals, the first control command comprising first rotation directions and first rotation angles of the display screen;
rotating the display screen according to the first rotation directions and the first rotation angles in the first control command;
obtaining second rotation angles of the display screen detected by a gravity sensor of the electronic device; and
stopping rotating the display screen when the second rotation angles of the display screen are equal to the first rotation angles in the first control command.

12. The non-transitory storage medium according to claim 11, wherein the first control command is detected from the digital audio signals using a local audio detection device of the electronic device.

13. The non-transitory storage medium according to claim 12, wherein the method further comprises:
sending the digital audio signals to a remote audio detection device of a server when a reliability index of the first control command detected by the local audio detection device is less than a preset value; and
receiving a second control command detected by the remote audio detection device of the server.

14. The non-transitory storage medium according to claim 13, wherein the method further comprises: displaying a prompt message on the display screen to prompt the user to output updated audio signals when a reliability index of the second control command detected by the remote audio detection device is less than the preset value.

15. The non-transitory storage medium according to claim 11, wherein the display screen is rotated by controlling a driving motor installed in a bracket of the display screen to rotate a rotating bearing of the bracket according to the first rotation directions and the first rotation angles of the handheld device.
